(19) United States
(12) Patent Application Publication
(10) Pub. No.: US 2015/0030025 A1
(43) Pub. Date: Jan. 29, 2015

(54) Management of Multiple Network Routes

(71) Applicant: Coraid, Inc., Redwood City, CA (US)

(72) Inventors: Samuel A. Hopkins, Foster City, CA (US); Sherman J. Sanders, Foster City, CA (US); Steven E. Stallion, Santa Clara, CA (US)

(73) Assignee: Coraid, Inc., Redwood City, CA (US)

(21) Appl. No.: 13/950,188

(22) Filed: Jul. 24, 2013

(51) Int. Cl. H04L 12/707; H04L 29/08

(52) U.S. Cl. CPC H04L 45/24; H04L 67/1097
USPC 370/392

(57) ABSTRACT

Managing network communications between network hosts that have multiple physical network ports coupled to the network. A first host broadcasts address resolution requests from first physical network ports of the first host and receives responses to the address resolution requests from second physical network ports of a second host. The responses include respective connection bandwidths of the second physical network ports. The first host generates connectivity information describing a plurality of available communication routes in the network between first physical network ports of the first host and second physical network ports of the second host based on the responses, from which a subset of available communication routes can be selected for data transfer.

### BACKGROUND

1. Field of the Disclosure

This disclosure pertains in general to network communication, and in particular to managing network communications between network hosts that have multiple physical network ports coupled to a network.

2. Description of the Related Art

Hosts systems in a networked environment, such as a storage area network (SAN), can each have multiple physical network ports that couple the host to the network. This creates multiple routes in the network through which the hosts can communicate with each other. The ports can be also configured with mismatched connection bandwidths (e.g. 100 Mb/s, 1 Gb/s). Due to the large number of available routes and potential configurations of the ports, it is difficult for the host systems to automatically identify an optimal subset of the routes that uses the routes efficiently.

### SUMMARY

Embodiments of the present disclosure are related to managing network communications between network hosts that have multiple physical network ports coupled to the network. In one embodiment, a method of operations is performed in a first host that communicates with a second host through a network. The first host includes a plurality of first physical network ports and the second host includes a plurality of physical network ports that are coupled to the network.

The first host broadcasts address resolution requests from the first physical network ports of the first host to the second physical network ports of the second host. The first host then receives responses to the address resolution requests from the second physical network ports of the second host. The responses to the address resolution requests include respective connection bandwidths for the second physical network ports. Using the responses, the first host generates connectivity information describing a plurality of available communication routes in the network between a plurality of first physical network ports of the first host and a plurality of second physical network ports of the second host. The connectivity information can also describe the respective connection bandwidths of the second physical network ports.

Once the connectivity information is generated, the first host selects a subset of the available communication routes for data transfer via the network between the first host and the second host based on the respective connection bandwidths of the second physical network ports. The first host then transfers data with the second host via the subset of the available communication routes. By selecting communication routes in this manner, the first host can automatically select a subset of routes that result in efficient use of network bandwidth. Additionally, the selected subset of routes can be a minimum subset of the available communication routes that fully utilizes all available bandwidth of at least one of the first physical network ports or the second physical network ports.

### BRIEF DESCRIPTION OF THE DRAWINGS

The teachings of the embodiments disclosed herein can be readily understood by considering the following detailed description in conjunction with the accompanying drawings.

Figure (FIG. 1 is a high-level block diagram of a computing environment for network communication across a storage area network, according to one embodiment.

FIG. 2 is a detailed view of a networking module of FIG. 1, according to one embodiment.

FIG. 3 is a flowchart illustrating a process of network communications performed by the networking module of FIG. 1 according to one embodiment.

FIG. 4 is a flowchart illustrating a more detailed view for the step of selecting a subset of routes from FIG. 3, according to one embodiment.

FIG. 5 is a hardware architecture of Network HostA from FIG. 1, according to one embodiment.

### DETAILED DESCRIPTION

The Figures (FIG.) and the following description relate to various embodiments by way of illustration only. It should be noted that from the following discussion, alternative embodiments of the structures and methods disclosed herein will be readily recognized as viable alternatives that may be employed without departing from the principles discussed herein.

Reference will now be made in detail to several embodiments, examples of which are illustrated in the accompanying figures. It is noted that wherever practicable similar or like reference numbers may be used in the figures and may indicate similar or like functionality. The figures depict various embodiments for purposes of illustration only. One skilled in the art will readily recognize from the following description that alternative embodiments of the structures and methods illustrated herein may be employed without departing from the principles described herein.

Embodiments disclosed herein describe a system and process for route management in a network environment when there are multiple hosts connected to the network, each of which has multiple physical network ports. The hosts automatically discover each other during address resolution and provide information about the connection bandwidths of their ports to the other hosts. Each host generates connectivity information describing all of the available routes for communicating with another host and which can also describe the connection bandwidths of the ports of the other host. From the connectivity information a subset of the available routes is selected for transferring data between the hosts.

FIG. 1 is a high-level block diagram of a computing environment 100 for network communication across a storage area network (SAN) 102, according to one embodiment. The computing environment 100 includes a network host A 110 (HostA) and a network host B 130 (HostB) connected to a SAN 120. In one embodiment, the computing environment 100 may exist within a datacenter. Only two hosts 110 and 130 are shown in FIG. 1 to simplify and clarify the description. In other embodiments the computing environment 100 can have a larger number of hosts 110 and 130.

SAN 120 is a dedicated network that provides access to consolidated, block level data storage. The SAN 120 may include communication links using technologies such as Ethernet. In other embodiments the communication links can use other technologies such as Fibre Channels or the like. HostA 110 and HostB 130 can communicate over the SAN 120 using a communication protocol such as ATA over Ethernet (AoE), Fiber Channel Protocol (FCP), Fiber Channel over Ethernet (FCoE), or other appropriate communication protocol. The SAN 120 can be located in one physical location or can span multiple physical locations. The SAN 120 may include one or more network switches (not shown) that route communications in the SAN 120 between HostA 110 and HostB 130.

HostA 110 and HostB 130 are both computing devices, such as server class computers. HostA 110, also known as an initiator host, initiates data transfer with HostB 130 across the SAN 120. HostB 130, also known as a storage host, provides storage services to HostA 110 through the SAN 120. HostB 130 includes several storage devices 140, such as magnetic disk drives, solid state drives, etc. HostB 130 forms the storage devices 140 into logical unit numbers (LUNs) which are assigned to HostA 110, accessed by HostA 110 via the SAN 120 and appear as local storage to HostA 110. In some embodiments a LUN may be shared among multiple network hosts.

Both HostA 110 and Host B 130 include several physical network ports 112 and 132, respectively, that are coupled to the SAN 120. HostA 110 includes ports 112, and HostB 130 includes ports 132. A physical network port is piece of hardware that provides physical access to the SAN 120 through a wired (or wireless) connection. An example of a physical network port is an Ethernet card. When connected to the SAN 120, each port negotiates a network connection bandwidth (e.g. 100 Mb/s, 1 Gb/s) with the SAN 120. The network connection bandwidth of a port defines the rate at which data is transferred with the SAN 120 through the port. In some instances the negotiated network connection bandwidth of a port may be lower than the maximum bandwidth of a port due to the limitations of the SAN 120. Some of the physical network ports may have different network connection bandwidths. For example port A0 112 may operate at 100 Mb/s while port A1 112 and port B0 132 operate at 1 Gb/s.

Each port has a unique physical address that can be used by other hosts to communicate with the port. The physical address may be hardwired into the port such that it is not modifiable. For example, an Ethernet based port may have a unique media access control (MAC) address. Each host (e.g. HostA 110 and HostB 130) has a different network address that is typically unique across the SAN 120. A network address is used as a higher order identifier for a host that is independent of the physical addresses. An example of a network address in the AoE protocol is a major.minor address. Another example of a network address is an internet protocol (IP) address or similar type of address. Each network host thus has multiple physical addresses and a single network address that spans the physical addresses.

HostA 110 and HostB 130 include respective networking modules 114 and 134. For ease of understanding only the networking module 114 of HostA 110 will be described herein. However, it is understood that the description of networking module 114 can also apply to networking module 134.

Networking module 114 communicates with HostB 130 to discover available communication routes in the SAN 120 between HostA 110 and Host B 130. Because HostA 110 has (m) number of ports 112 and network host B 130 has (n) number of ports 132, there are a total of (m×n) available communication routes between HostA 110 and HostB 130.

When HostA 110 is first attached to the SAN 120, the available communication routes are unknown to HostA 110. To discover the available communication routes, networking module 114 broadcasts address resolution request packets to network host B 130 by transmitting address resolution request packets through the SAN 120. Address resolution is a phase of network communications during which a host resolves network addresses of other hosts to physical addresses of the other hosts. The result of address resolution is that the mappings between network addresses and physical addresses are known. Address resolution is implemented in many different network standards, such as in IP communications and others.

A different address resolution request packet is broadcast from each HostA port 112. The HostB ports 132 receive the address resolution request packets and respond by providing address resolution response packets to the HostA ports 112. The address resolution response packets also include information about the connection bandwidths of the remote HostB ports 132. The networking module 114 processes the address resolution response packets to generate connectivity information, which describes all of the available communication routes between HostA 110 and HostB 130 and the connection bandwidths of the HostB ports 132.

Once the connectivity information is generated, the networking module 114 uses the connectivity information to select a subset of the communication routes for data transfer with HostB 130. The subset of communication routes is selected in a manner that optimizes data transfer between HostA 110 and HostB 130, even if one host has a different number of ports and / or ports with different connection bandwidths than the other host. The selection can be performed in an automatic manner at HostA 110 without the need for user intervention because the available routes and connection bandwidths of the HostB ports 132 are known to HostA 110. Further, obtaining connection bandwidth information during address resolution provides a simple and easy to implement technique for obtaining information about the capabilities of the HostB ports 130 that requires only minor modifications to existing address resolution mechanisms.

In other embodiments, the SAN 120 can be replaced with a generic network that represents the communication pathways between the HostA 110 and HostB 130. The network can be an internal network or the Internet. In one embodiment, the network uses standard communications technologies and/or protocols. Thus, the network can include links using technologies such as Ethernet, 802.11, integrated services digital network (ISDN), digital subscriber line (DSL), asynchronous transfer mode (ATM), etc. Similarly, the networking protocols used on the network can include the transmission control protocol/Internet protocol (TCP/IP), the hypertext transport protocol (HTTP), the simple mail transfer protocol (SMTP), the file transfer protocol (FTP), etc. The data exchanged over the network 120 can be represented using technologies and/or formats including the hypertext markup language (HTML), the extensible markup language (XML), etc. In addition, all or some of the links can be encrypted using conventional encryption technologies such as the secure sockets layer (SSL), Secure HTTP and/or virtual private networks (VPNs).

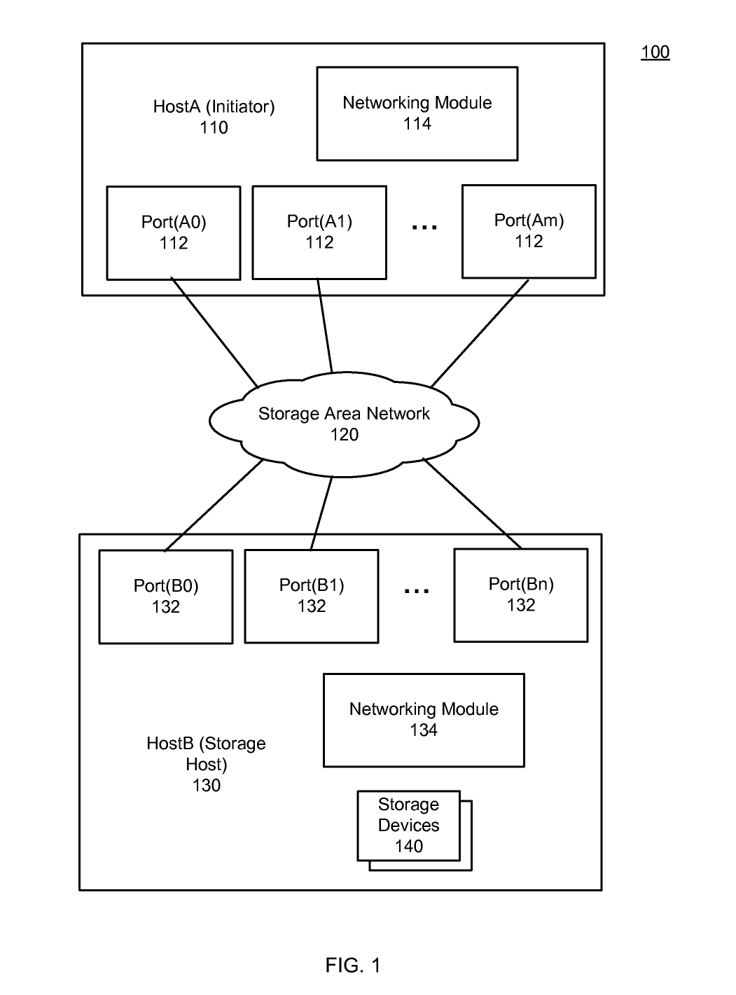

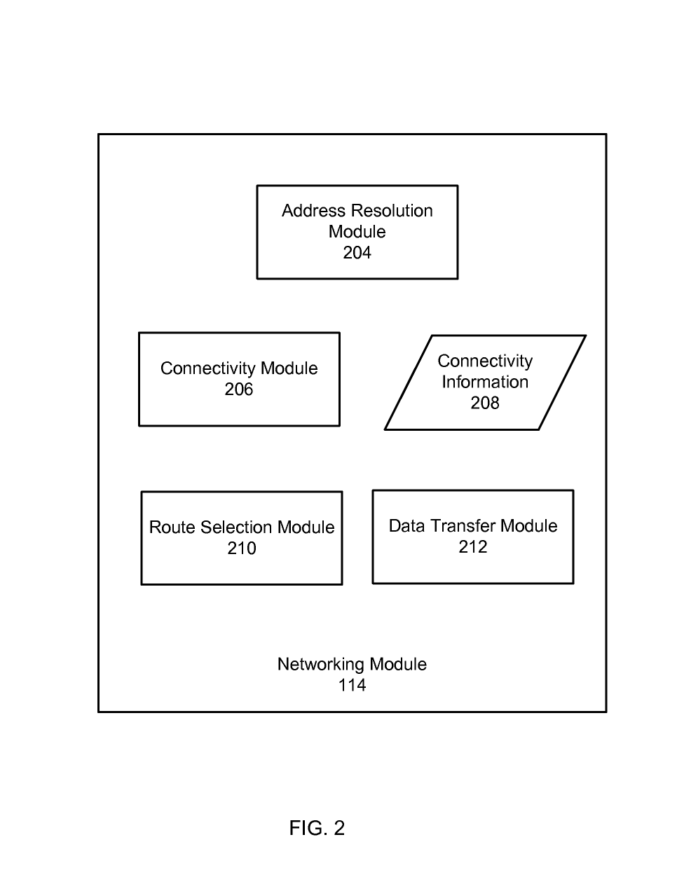

FIG. 2 is a detailed view of a networking module 114 of FIG. 1, according to one embodiment. Networking module 114 includes an address resolution module 204, a connectivity module 206, connectivity information 208, a route selection module 210 and a data transfer module 212. In other embodiments there may be a different number of modules and the functionality described as being in one module may be implemented in a different module.

The address resolution module 204 generates address resolution request packets and broadcasts the address resolution request packets from the HostA ports 112 across the SAN 120. A different address resolution request packet is broadcast from each HostA port 112. For example, one address resolution request packet is broadcast from port(A0) 112 and another address resolution request packet is broadcast from port(A1) 112. An address resolution request packet broadcast from a given HostA port 112 can include the following fields, among others: the physical address of the HostA port 112, the network address of the HostA port 112, and the network address of HostB 130. In some embodiments the address resolution request packet can include the connection bandwidth of the HostA port 112. The following is an example of fields in an address resolution request packet sent by HostA 110:

| HostA port physical address | 00-B0-D0-86-BB-F7 |
|---|---|
| HostA network address | 63.197.333.225 |
| HostB network address | 63.197.333.222 |

The address resolution request packet is received at the HostB ports 132, which respond by providing responses to the address resolution request packet. Each HostB port 132 provides its own response to the address resolution request packet in the form of an address resolution response packet. For example, port(B0) 132 returns an address resolution response packet to port(A0) 112 and port(B1) 132 also returns an address resolution response packet to port(A0) 112. The address resolution response packet from a HostB port 132 can include the following fields: the physical address of the HostB Port 132, a connection bandwidth of the HostB Port 132, the network address of HostB 130, the physical address of a HostA Port 112 and the network address of HostA 112. The following is an example of fields in an address resolution response packet sent by HostB:

| HostB port physical address | 1A-23-55-CE-15-F7 |
|---|---|
| HostB port bandwidth | 1 Gb/s |
| HostB network address | 63.197.333.222 |
| HostA port physical address | 00-B0-D0-86-BB-F7 |
| HostA network address | 63.197.333.225 |

Notably, the address resolution response packets include a field for the bandwidth of the HostB Port 132. Conventional address resolution packets do not have a field for port bandwidth, so this bandwidth information may be transmitted in an optional extension field of an address resolution response packet. For backwards compatibility, the optional extension field may be ignored by hosts that do not support the optional extension field. The address resolution module 204 then receives and decodes the address resolution response packets.

The connectivity module 206 processes the address resolution response packets and generates connectivity information 208 describing available communication routes between HostA 110 and HostB 130 as well as the connection bandwidths of the HostB ports 132. The available routes can be determined from the address resolution response packets. Each time an address resolution response packet is received at a HostA Port from a HostB Port, the connectivity module 206 assumes an available communication route exists between the HostA Port and the HostB Port and adds the route to the connectivity information 208.

In one embodiment, the connectivity information 208 includes data that represents a connectivity matrix or connectivity map of the available communication routes. The connectivity information 208 can be stored in a computer-readable medium for later access, such as in a random access memory, solid state memory, etc. The connectivity information 208 includes a list of route entries for the available communication routes. Each route entry can include fields for: a timestamp of when the route entry was created or last updated, the physical address of a HostA port 112, the HostA port bandwidth, the network address of HostB 130, the physical address of a HostB port 132, and the HostB port bandwidth. Most of the fields can be determined from the address resolution response packets, while the HostA port bandwidth can be determined locally by the connectivity module 206. The following is an example of a route entry for a single route:

| Timestamp | 1:30 PM, 7/15/2013 |
|---|---|
| HostA port physical address | 00-B0-D0-86-BB-F7 |
| HostA port bandwidth | 100 Mb/s |
| HostB port physical address | 1A-23-55-CE-15-F7 |
| HostB port bandwidth | 1 Gb/s |
| HostB network address | 63.197.333.222 |

A route entry thus defines a communication route between a single HostA port 112 and a single HostB port 132. Collectively, the route entries represent all of the available communication routes through the SAN 120 between HostA 110 and HostB 130.

To keep the connectivity information 208 up to date, the address resolution module 204 periodically broadcasts new address resolution request packets from the HostA ports 112. The connectivity module 206 can cull stale entries from the connectivity information 208 to account for changes in the SAN 120 if no responses to the address resolution request packets are received. The culling can occur at periodic intervals, such as 2.5 times the broadcast time of address resolution request packets. For example, if the periodic broadcast time is 3 seconds, route entries may be invalidated if they are 7.5 seconds old. The address resolution module 204 and connectivity module 206 thus work together to generate and continuously update the connectivity information 208.

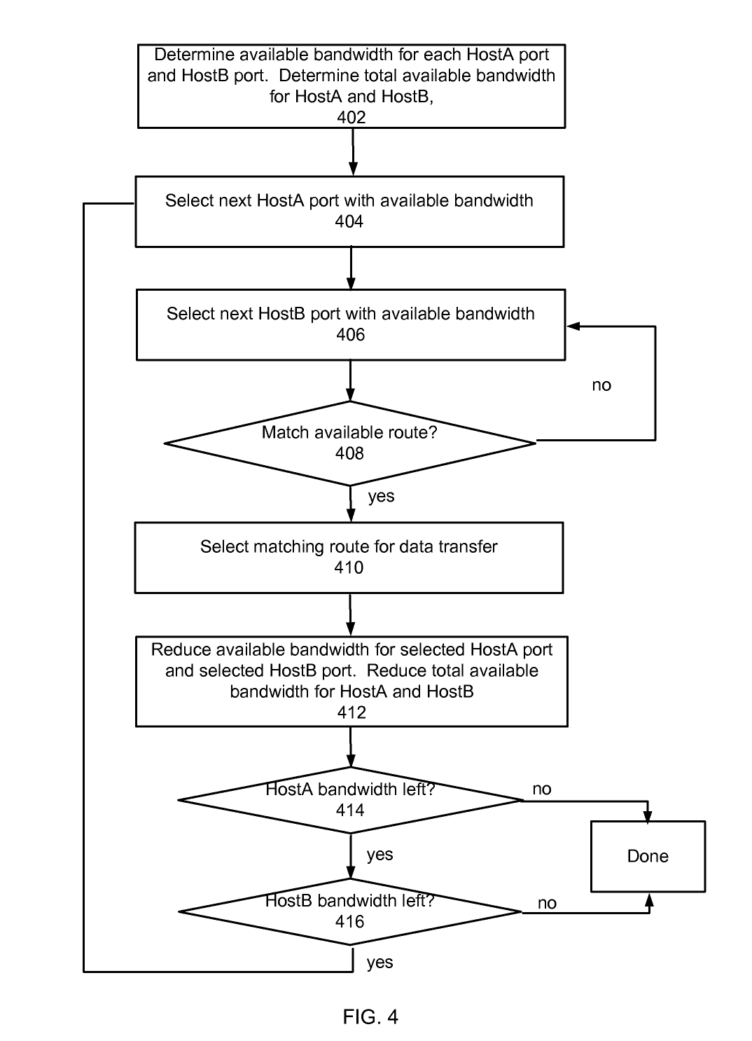

The route selection module 210 selects a subset of the communication routes from the connectivity information 208 for data communications with remote HostB 110. The route selection module 210 attempts to select a minimum number of routes that still consumes all of the available bandwidth for the HostA ports 112 or the HostB ports 132. The exact communication routes that are selected depend on several factors, such as the number of HostA ports 112, the number of HostB ports 132, the bandwidths of the HostA ports 112, and the bandwidths of the HostB ports 132. Route selection can also re-occur periodically as the connectivity information 208 is updated. Route selection will be described in greater detail by reference to FIG. 4.

The data transfer module 212 transfers data with HostB 130 via the subset of communication routes selected by the route selection module 210. Data transfer can include either receiving data from HostB 130 or transmitting data to HostB 130 for storage into the storage devices 140. The data is divided amongst the selected communication routes in order to make full use of the available bandwidth between HostA 110 and HostB 130.

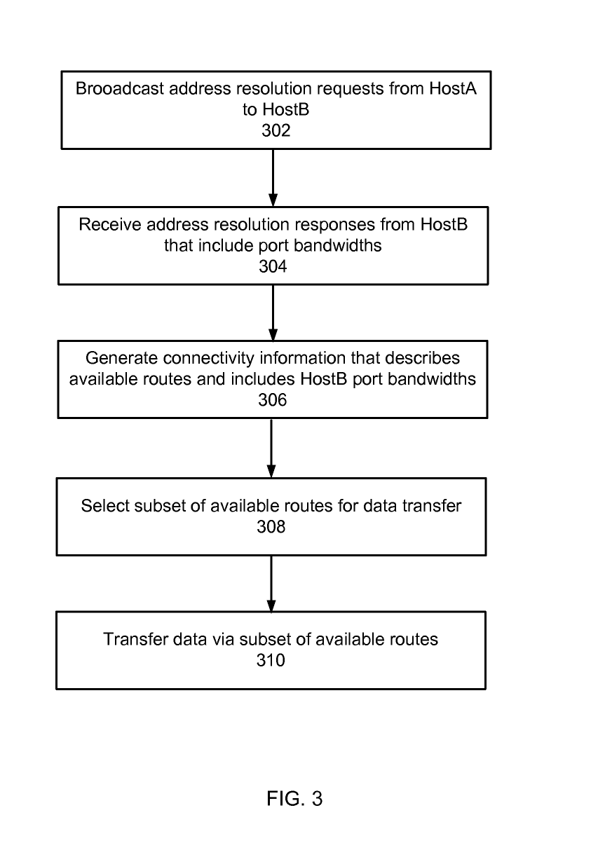

FIG. 3 is a flowchart illustrating a process of network communications performed by the networking module 114 of FIG. 1, according to one embodiment. In step 302, address resolution request packets are broadcast from HostA 110 to HostB 130. Separate address resolution request packets are broadcast from each HostA port 112. In step 304, address resolution response packets are received from the HostB ports 132 that describe the connection bandwidths of the HostB ports 132. In step 306, the address resolution response packets are used to generate connectivity information 208 that describes available communication routes between HostA 110 and HostB 130. The connectivity information also describes the connectivity bandwidths of the HostB ports 132. In step 308, using the connectivity information, a subset of the communication routes are selected for data transfer with HostB 130. In step 310, data is transferred with HostB 130 via the selected subset of communication routes.

FIG. 4 is a flowchart illustrating a more detailed view for the step 308 of selecting a subset of routes from FIG. 3, according to one embodiment. In step 402, the available bandwidth for each HostA port 112 and each HostB port 132 is determined. Initially the available bandwidth for each port is equal to the connection bandwidth for the port as indicated in the connectivity information 208. The total available bandwidth for HostA 110 is determined by combining the individual bandwidths of the HostA ports 112. The total available bandwidth for HostB 130 is also determined by combining the individual bandwidths of the HostB ports 132.

In step 404, the next hostA port with available bandwidth is selected. In step 404, the next HostB port 132 with available bandwidth is selected. In step 408 the selected HostA port 112 and the selected HostB port 132 are compared to the connectivity information 208 to determine if the HostA port 112 and HostB port 132 match an available route through the SAN 120. If there is a match, the communication route is selected for data transfer in step 410. For example, the selected communication route can be added to a table of selected communication routes. If there is not a match, the route selection process returns to step 406 to select the next HostB port 132 with available bandwidth.

In step 412, the available bandwidth for the selected HostA port 112 and the available bandwidth for the selected HostB port 132 are reduced, which indicates that some or all of the bandwidth of the ports has been allocated to a selected route. The amount of the reduction is equal to the smaller of the available bandwidth of the HostA port 112 and the HostB port 132. For example, if the available bandwidth for a HostA port is 1 Gb/s and the available bandwidth for a HostB port 132 is 100 Mb/s, both ports would have their available bandwidth reduced by 100 Mb/s. The total available bandwidth for both HostA 110 and HostB 112 are also reduced in the same manner.

In step 414 it is determined if HostA 110 has any available bandwidth remaining. If so, in step 416 it is determined if HostB 130 has any available bandwidth remaining. If either HostA 110 or HostB 130 has no remaining bandwidth, the route selection process is completed because all of the available bandwidth has been consumed and there is no more bandwidth to be allocated.

If both HostA 110 and HostB 130 have remaining bandwidth, the process returns to step 404 and selects the next HostA port 112 with available bandwidth instead of selecting the same HostA port 112 from the previous iteration of the route selection process. For example, if HostA port(A0) was selected in one iteration of the route selection process, the next iteration will select HostA port(A1) for route selection. As a result, the HostA ports 112 are selected in a round-robin manner (A0→A1→A2→A0→A1→A2) that balances data transmission across the ports of HostA. Similarly, in step 406 the next HostB port 132 with available bandwidth is selected instead of selecting the same HostB port 132 from the previous iteration of the route selection process. This also balances data transmission across the HostB ports 132. The process repeats until all available bandwidth for the HostA ports 113 or the HostB ports 132 is consumed.

The following examples illustrate route selections that are performed by the route selection process in FIG. 4.

### EXAMPLE 1

HostA 110 has four 10 Gb/s ports 112 and HostB 130 also has four 10 Gb/s ports 132. HostA's ports 112 are labeled A0, A1, A2 and A3. HostB's ports 132 are labeled B0, B1, B2 and B3. The full connectivity matrix of routes between HostA 110 and HostB 130 can be visually represented in Table 1A as follows:

TABLE 1A

| | B0 (10 Gb/s) | B1 (10 Gb/s) | B2 (10 Gb/s) | B3 (10 Gb/s) |
|---|---|---|---|---|
| A0 (10 Gb/s) | Available | Available | Available | Available |
| A1 (10 Gb/s) | Available | Available | Available | Available |
| A2 (10 Gb/s) | Available | Available | Available | Available |
| A3 (10 Gb/s) | Available | Available | Available | Available |

In Table 1A, there are 16 available communication routes between HostA 110 and HostB 130. HostA 110 could use every available route in transferring data with HostB 130. However, this is unnecessary. Instead, the networking module 114 selects a subset of the routes for data transfer, so that from the available routes, the selected subset of routes would be as follows:

TABLE 1B

| | B0 (10 Gb/s) | B1 (10 Gb/s) | B2 (10 Gb/s) | B3 (10 Gb/s) |
|---|---|---|---|---|
| A0 (10 Gb/s) | Selected | | | |
| A1 (10 Gb/s) | | Selected | | |
| A2 (10 Gb/s) | | | Selected | |
| A3 (10 Gb/s) | | | | Selected |

In Table 1B, the four selected routes represent the minimum subset of the available routes that still consumes all of the available bandwidth (40 Gb/s) between HostA 110 and HostB 130.

### EXAMPLE 2

HostA 110 has four 1 Gb/s Ports 112 and HostB 130 also has two 10 Gb/s Ports 132. HostA ports 112 are labeled A0, A1, A2 and A3. HostB ports 132 are labeled B0 and B1. The full connectivity matrix of routes between HostA 110 and HostB 130 can be visually represented in Table 2A as follows:

TABLE 2A

| | B0 (10 Gb/s) | B1 (10 Gb/s) |
|---|---|---|
| A0 (1 Gb/s) | Available | Available |
| A1 (1 Gb/s) | Available | Available |
| A2 (1 Gb/s) | Available | Available |
| A3 (1 Gb/s) | Available | Available |

In Table 2A, there are 8 available communication routes between HostA 110 and HostB 130. Route selection selects a subset of the routes for data transfer. Due to imbalance or mismatch between the bandwidths of the HostA ports 112 and the HostB ports 132, the selected subset of routes would be as follows:

TABLE 2B

| | B0 (10 Gb/s) | B1 (10 Gb/s) |
|---|---|---|
| A0 (1 Gb/s) | Selected | |
| A1 (1 Gb/s) | | Selected |
| A2 (1 Gb/s) | Selected | |
| A3 (1 Gb/s) | | Selected |

In Table 2B, the routes are selected such that HostB port B0 is matched with HostA ports A0 and A2. HostB port B1 is matched with HostA ports A1 and A3. The total bandwidth between HostA 110 and HostB 130 is 4 Gb/s, which is limited by the bandwidth of the HostA ports 112. The 4 Gb/s bandwidth is split between the HostB ports 132 to balance data traffic amongst the HostB ports 132.

Additionally, the routes are selected in a manner that can match ports with different connection bandwidths to each other. For example, HostB port B0 has 10 Gb/s bandwidth but is still matched against HostA port A0, which only has 1 Gb/s bandwidth.

### EXAMPLE 3

HostA 110 has four 10 Gb/s Ports 112 and HostB 130 also has two 10 Gb/s Ports 132. HostA ports 112 are labeled A0, A1, A2 and A3. HostB ports 132 are labeled B0 and B1. The full connectivity matrix of routes between HostA 110 and HostB 130 can be visually represented in Table 3A as follows:

TABLE 3A

| | B0 (10 Gb/s) | B1 (10 Gb/s) |
|---|---|---|
| A0 (10 Gb/s) | Available | Available |
| A1 (10 Gb/s) | Available | Available |
| A2 (10 Gb/s) | Available | Available |
| A3 (10 Gb/s) | Available | Available |

In Table 3A, there are 8 available communication routes between HostA 110 and HostB 130. Route selection selects a subset of the routes for data transfer. Due to imbalance between the number of HostA ports 112 and the number of HostB ports 132, the selected subset of routes would be as follows:

TABLE 3B

| | B0 (10 Gb/s) | B1 (10 Gb/s) |
|---|---|---|
| A0 (10 Gb/s) | Selected | |
| A1 (10 Gb/s) | | Selected |
| A2 (10 Gb/s) | | |
| A3 (10 Gb/s) | | |

In table 3B, two of the routes (A0-B0 and A1-B1) are selected for data transfer. The HostA ports A2 and A3 are not useful for data transfer as the total bandwidth is limited by the HostB ports 132 to 20 Gb/s. Additionally, using additional routes actually creates a “Y” configuration whereby HostA 110 can create unnecessary network congestion by attempting to send 40 Gb/s of data when HostB 130 can only sustain 20 Gb/s of data. The two selected routes thus represent the minimum subset of available routes that still consume all of the available bandwidth (20 Gb/s) between HostA 110 and HostB 130.

### Example Computer Architecture

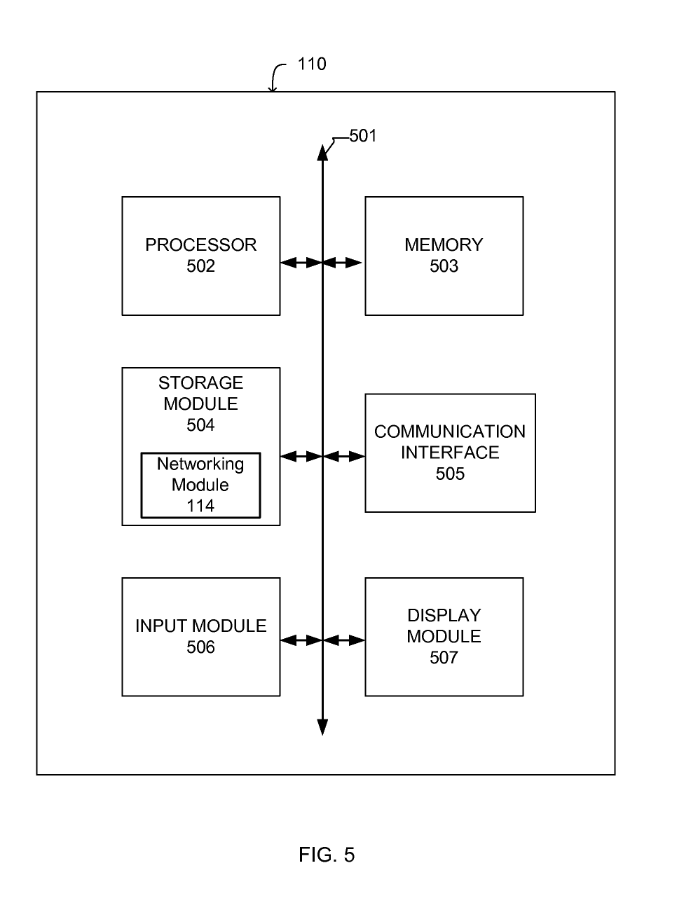

FIG. 5 illustrates the hardware architecture of Network HostA 110 (or Network HostB 130), according to one embodiment. In one embodiment, HostA is a server computer including components such as a processor 502, a memory 503, a storage module 504, an input module (e.g., keyboard, mouse, and the like) 506, a display module 507 and a communication interface 505, exchanging data and control signals with one another through a bus 501. The storage module 504 is implemented as one or more non-transitory computer readable storage media (e.g., hard disk drive, solid state memory, etc.), and stores software instructions that are executed by the processor 502 in conjunction with the memory 503 to implement the network communications described herein. For example, the storage module 504 may include instructions in the form of a networking module 114. Operating system software and other application software may also be stored in the storage module 504 to run on the processor 502.

As can be seen from the description above, the embodiments herein discover all available routes between hosts that have multiple physical network ports, as well as the connection bandwidths of the ports during address resolution. Using this information, a subset of routes can be selected for data transfer between the hosts. The routes are selected in a manner that fully utilizes the available bandwidth between the two hosts while also balancing data traffic across the ports of the hosts.

Upon reading this disclosure, those of skill in the art will appreciate still additional alternative designs for network communications between network hosts. Thus, while particular embodiments and applications of the present disclosure have been illustrated and described, it is to be understood that the embodiments are not limited to the precise construction and components disclosed herein and that various modifications, changes and variations which will be apparent to those skilled in the art may be made in the arrangement, operation and details of the method and apparatus of the present disclosure disclosed herein without departing from the spirit and scope of the disclosure as defined in the appended claims.

What is claimed is:

1. A computer implemented method of operations in a first host that communicates with a second host through a network, comprising:
broadcasting address resolution requests from a plurality of first physical network ports of the first host to a plurality of second physical network ports of the second host;
receiving responses to the address resolution requests from the second physical network ports of the second host, the responses to the address resolution requests including respective connection bandwidths of the second physical network ports;
generating connectivity information describing a plurality of available communication routes in the network between the plurality of first physical network ports of the first host and the plurality of second physical network ports of the second host based on the responses to the address resolution requests;
selecting a subset of the available communication routes for data transfer via the network between the first host and the second host based on the respective connection bandwidths of the second physical network ports; and
transferring data with the second host via the subset of the available communication routes.

2. The method of claim 1, wherein the respective port bandwidths for the second physical network ports are included in optional extension fields of the responses to the address resolution requests.

3. The method of claim 1, wherein the connectivity information includes a plurality of entries for the available communication routes, an entry for a available communication route identifying a respective one of the first physical network ports, a respective one of the second physical network ports and a respective connection bandwidth for the respective one of the second physical network ports.

4. The method of claim 1, wherein selecting the subset of the available communication routes for data transfer via the network between the first host and the second host comprises:
selecting the subset of the available communication routes for data transfer via the network between the first host and the second host based on respective connection bandwidths of the first physical network ports and the respective connection bandwidths of the second physical network ports.

5. The method of claim 4, wherein selecting the subset of the available communication routes comprises:
selecting the subset of the available communication routes by allocating the respective connection bandwidths of the first physical network ports and the respective connection bandwidths of the second physical network ports until the respective connection bandwidths for either the first physical network ports or the second physical network ports are consumed.

6. The method of claim 1, wherein the subset of available communication routes are selected to balance data transfer across at least one of the first physical network ports or the second physical network ports.

7. The method of claim 1, wherein the subset of available communication routes is a minimum subset of the available communication routes that fully utilizes all available bandwidth of at least one of the first physical network ports or the second physical network ports.

8. The method of claim 1, wherein a first communication route in the subset of communication routes is a communication route between a first physical network port and a second physical network port having different connection bandwidths.

9. The method of claim 1, wherein the first physical ports have different physical addresses and a single network address.

10. The method of claim 1, wherein the network is a storage area network (SAN), the first host is an initiator host and the second host is a storage host that provides storage services for the initiator host via the SAN through a SAN protocol, wherein generating connectivity information comprises:
generating connectivity information describing a plurality of available communication routes in the SAN between a plurality of first physical network ports of the initiator host and a plurality of second physical network ports of the storage host that provide storage services for the initiator host via the SAN.

11. A non-transitory computer readable medium storing processor executable instructions for network communications between a first host that communicates with a second host through a network, the instructions comprising instructions for:
broadcasting address resolution requests from a plurality of first physical network ports of the first host to a plurality of second physical network ports of the second host;
receiving responses to the address resolution requests from the second physical network ports of the second host, the responses to the address resolution requests including respective connection bandwidths of the second physical network ports;
generating connectivity information describing a plurality of available communication routes in the network between the plurality of first physical network ports of the first host and the plurality of second physical network ports of the second host based on the responses to the address resolution requests;
selecting a subset of the available communication routes for data transfer via the network between the first host and the second host based on the respective connection bandwidths of the second physical network ports; and
transferring data with the second host via the subset of the available communication routes.

12. The computer readable medium of claim 11, wherein the respective port bandwidths for the second physical network ports are included in optional extension fields of the responses to the address resolution requests.

13. The computer readable medium of claim 11, wherein the connectivity information includes a plurality of entries for the available communication routes, an entry for a available communication route identifying a respective one of the first physical network ports, a respective one of the second physical network ports and a respective connection bandwidth for the respective one of the second physical network ports.

14. The computer readable medium of claim 11, wherein selecting the subset of the available communication routes for data transfer via the network between the first host and the second host comprises:
selecting the subset of the available communication routes for data transfer via the network between the first host and the second host based on respective connection bandwidths of the first physical network ports and the respective connection bandwidths of the second physical network ports.

15. The computer readable medium of claim 14, wherein selecting the subset of the available communication routes comprises:
selecting the subset of the available communication routes by allocating the respective connection bandwidths of the first physical network ports and the respective connection bandwidths of the second physical network ports until the respective connection bandwidths for either the first physical network ports or the second physical network ports are consumed.

16. The computer readable medium of claim 11, wherein the subset of available communication routes are selected to balance data transfer across at least one of the first physical network ports or the second physical network ports.

17. The computer readable medium of claim 11, wherein the subset of available communication routes is a minimum subset of the available communication routes that fully utilizes all available bandwidth of at least one of the first physical network ports or the second physical network ports.

18. The computer readable medium of claim 11, wherein a first communication route in the subset of communication routes is a communication route between a first physical network port and a second physical network port having different connection bandwidths.

19. The computer readable medium of claim 11, wherein the first physical ports have different physical addresses and a single network address.

20. The computer readable medium of claim 11, wherein the network is a storage area network (SAN), the first host is an initiator host and the second host is a storage host that provides storage services for the initiator host via the SAN through a SAN protocol, wherein generating connectivity information comprises:
generating connectivity information describing a plurality of available communication routes in the SAN between a plurality of first physical network ports of the initiator host and a plurality of second physical network ports of the storage host that provide storage services for the initiator host via the SAN.
